(19) United States
(12) Patent Application Publication
(10) Pub. No.: US 2006/0073326 A1
(43) Pub. Date: Apr. 6, 2006

(54) Retardation film and method for manufacturing the same

(76) Inventors: Kenji Shirai, Tokyo-to (JP); Takashi Kuroda, Tokyo-to (JP); Keiji Kashima, Tokyo-to (JP)

Correspondence Address: LADAS & PARRY LLP, 224 SOUTH MICHIGAN AVENUE, SUITE 1600, CHICAGO, IL, 60604, US

(21) Appl. No.: 10/959,709

(22) Filed: Oct. 6, 2004

(51) Int. Cl. B32B 5/16

(52) U.S. Cl. 428/323; 428/411.1; 427/162

(57) ABSTRACT

A main object of the present invention is to provide a retardation film capable of easily obtaining an optional retardation value even for a small amount without problems, of peeling off of the retardation layer from the base material or the like, generated in a case of forming the retardation layer. In order to achieve the above-mentioned object, the present invention provides a retardation film, wherein a material having refractive index anisotropy is contained in a polymer film, and the material having refractive index anisotropy has a concentration gradient in a thickness direction of the polymer film.

### BACKGROUND OF THE INVENTION

1. Field of the Invention

The present invention relates to a retardation film, used in a condition installed in a liquid crystal display or the like, and a method for manufacturing the same.

2. Description of the Related Art

As a conventional common liquid crystal display, as shown in FIG. 7, one comprising a polarizing plate 102A on an incident side, a polarizing plate 102B on an outgoing side and a liquid crystal cell 104 can be presented. The polarizing plates 102A and 102B are constructed so as to selectively transmit only the linear polarization having an oscillation surface in a predetermined oscillation direction (shown schematically by an arrow in the figure), and are disposed facing with each other in a cross nicol state such that the oscillation directions thereof have a relationship perpendicular with each other. Moreover, the liquid crystal cell 104, including a large number of cells corresponding to pixels, is disposed in between the polarizing plate 102A and polarizing plate 102B.

Here, in such a liquid crystal display 100, for example, in the case of the liquid crystal cell 104 adopting a VA (vertical alignment) system, in which a nematic liquid crystal having a negative dielectric anisotropy is sealed (the liquid crystal director is shown schematically by a dotted line in the figure), the linear polarization transmitted the polarizing plate 102A on the incident side is transmitted without being its phase shifted, at the time of transmitting a non-driven state cell part among the liquid crystal cell 104, so as to be blocked by the polarizing plate 102B on the outgoing side. In contrast, at the time of transmitting a driven state cell part among the liquid crystal cell 104, the phase of the linear polarization is shifted so that light of an amount according to the phase shift amount is transmitted through and outgoes from the polarizing plate 102B on the incident side. Accordingly, by optionally controlling the driving voltage of the liquid crystal cell 104 per each cell, a desired image can be displayed on the side of the polarizing plate 102B on the outgoing side. The liquid crystal display 100 is not limited to ones having the above-mentioned configuration of the light transmission and blockage. On the other hand of a liquid crystal display, in which the outgoing light from the non-driven state cell part among the liquid crystal cell 104 is transmitted through and outgoes from the polarizing plate 102B on the outgoing side, a liquid crystal display, in which the outgoing light from the driven state cell part is blocked by the polarizing plate 102B on the outgoing side, is also proposed.

Considering the case of the linear polarization transmitting the non-driven state cell part among the liquid crystal cell 104 of the above-mentioned VA system, since the liquid crystal cell 104 have the double refractivity so that a refractive index in the thickness direction and a refractive index in the surface direction differ with each other, incident light along the normal line of the liquid crystal cell 104, among the linear polarization transmitted through the polarizing plate 102A on the incident side, is transmitted without the phase being shifted. However, the phase of the incident light entering in an inclined direction to the normal line of the liquid crystal cell 104, among the linear polarization transmitted through the polarizing plate 102A on the incident side, is shifted when the light is transmitted through the liquid crystal cell 104 so as to be elliptically polarized. This phenomenon is derived from the liquid crystal molecules, aligned in the perpendicular direction in the liquid crystal cell 104, acting as a positive C plate. The magnitude of the retardation generated with respect to the light transmitted through the liquid crystal cell 104 (transmitted light) depends also on the double refractive value of the liquid crystal molecules sealed in the liquid crystal cell 104, the thickness of the liquid crystal cell 104, the wavelength of the transmitted light or the like.

Due to the above-mentioned phenomenon, even when a cell of the liquid crystal cell 104 is in the non-driven state so that the linear polarization is inherently transmitted as it is, so as to be blocked by the polarizing plate 102B on the outgoing side, a part of the light, outgoing in the inclined direction to the normal line of the liquid crystal cell 104, is leaked form the polarizing plate 102B on the outgoing side.

Therefore, in the above-mentioned conventional liquid crystal display 100, there is a problem of a display quality deterioration of an image observed from the inclined direction to the normal line of the liquid crystal cell 104 (a problem of the visual angle dependency), compared with an image observed from the front side, mainly due to the contrast decline.

To improve the problem of the visual angle dependency in the above-mentioned conventional liquid crystal display 100, various techniques have been developed so far. As an example, as disclosed in Japanese Patent Application Laid-Open (JP-A) Nos. 3-67219 and 4-322223, a liquid crystal display, using a retardation layer (retardation layer showing the double refractivity) having a cholesteric regularity molecular structure, is known. By disposing such the retardation layer in between the liquid crystal cells and the polarizing plates, an optical compensation is carried out.

Here, in the retardation optical element having the cholesteric regularity molecular structure, the selective reflection wavelength, represented by λ=nav·p (p: helical pitch in a helical structure of the liquid crystal molecule, nav: average refractive index in an orthogonal plane to the helical axis), is adjusted to be shorter or longer than the wavelength of the transmitted light, for example as disclosed in JP-A Nos. 3-67219 or 4-322223.

In contrast, for example as disclosed in JP-A No. 10-312166, a liquid crystal display, in which the optical compensation is carried out by using a retardation layer (retardation layer showing the double refractivity) comprising a disc like compound and by disposing such retardation layer in between liquid crystal cells and a polarizing plate, is also known.

In the above-mentioned retardation optical element, as in the case of the above-mentioned liquid crystal cells, the phase of the linear polarization incident, entering in an inclined direction to the normal line of the retardation layer, is shifted when it is transmitted through the retardation layer so as to be elliptically polarized. This phenomenon is derived from the molecular alignment of the cholesteric regularity and the disc like compound itself acting as a negative C plate. The magnitude of the retardation generated with respect to the light transmitted through the retardation layer (transmitted light) depends also on the double refractive value of the liquid crystal molecules in the retardation layer, the thickness of the retardation layer, the wavelength of the transmitted light or the like.

Therefore, by using the above-mentioned retardation layer, the problem of the visual angle dependency of the liquid crystal display can dramatically be improved by optionally designing the retardation layer such that the retardation generated in the VA system liquid crystal cells, which act as the positive C plate, and the retardation generated in the retardation layer, which act as the negative C plate, offset with each other.

In this case, the visual angel dependency of the polarizing plate can be improved, with the remaining positive plate C component and an A plate prepared separately, by making the sum of the retardation values in the thickness direction of the above-mentioned positive C plate and the above-mentioned negative C plate positive. That is, by making the absolute value of the retardation value in the thickness direction of the above-mentioned negative C plate smaller than the absolute value of the retardation value in the thickness direction of the above-mentioned positive C plate. For example, the improvement of the visual angle dependency of the polarizing plate with the positive C plate and A plate is disclosed in J. Chen et al., SID98 Digest, p315 (1998) and T. Ishibabe et al., SID00 Digest, p1094 (2000).

However, in the above-mentioned retardation layer, there is a problem of an adhesion between the retardation layer and the base material (for example, the TAC (cellulose triacetate film) as the protecting film for the polarizing layer).

In order to solve the problem, as disclosed in for example JP-A No. 2003-207644, improvement of the adhesion, by treating the liquid crystal and the alignment film with heat, is proposed. However, in this method, when the base material is not a glass substrate but a base material having low moisture and heat resistance (for example, TAC), the base material is stretched or shrunk by the influence of the moisture so that the liquid crystal layer may be peeled off due to the above. And thus, it is not a satisfying method for base materials easily influenced by the moisture.

As a method free of the above-mentioned problems, for example as disclosed in JP-A Nos. 2001-111914 and 2001-249223, a method of forming a cellulose acetate film by mixing a retardation increasing agent in a cellulose acetate solution, at the time of manufacturing a cellulose acetate film, can be adopted. However, by such method, since the retardation increasing agent should be mixed at the time of forming the cellulose acetate film, the amount of one lot is inevitably made larger. Therefore, there is a problem that optional retardation can hardly be obtained for a small amount.

### SUMMARY OF THE INVENTION

The present invention has been achieved in view of the above-mentioned problems, and a main object thereof is to provide a retardation film capable of easily obtaining an optional retardation value even for a small amount without the above-mentioned problems of peeling off of the retardation layer from the base material or the like, generated in a case of forming the retardation layer.

In order to achieve the above-mentioned object, the present invention solves the above-mentioned problems by providing a retardation film, wherein a material having refractive index anisotropy (hereinafter, it may be referred to also as a refractive index anisotropic material) is contained in a polymer film, and the refractive index anisotropic material has a concentration gradient in a thickness direction of the polymer film.

In the present invention, for example, by coating a coating solution, in which a refractive index anisotropic material is dissolved in a solvent, on the surface of a polymer film and swelling, it is possible to fill the vicinity of the polymer film surface with the refractive index anisotropic material easily. Thereby, a retardation film, having concentration gradient of the refractive index anisotropic material in a direction of the above-mentioned polymer film thickness, can be obtained. Moreover, by changing the amount or the concentration of the above-mentioned coating solution, the retardation value as the retardation film can easily be changed. Therefore, there is an advantage that a retardation film having an optional retardation value can easily be obtained in a small lot. Moreover, since it is not a conventional retardation film having a retardation layer formed on a base material, there is an advantage that a problem of the peeling off of the retardation layer from the base material is not generated.

In the present invention, it is preferable that the polymer film has regularity in the refractive index. By using such polymer film, the refractive index regularity of the above-mentioned polymer film can be reinforced by the refractive index anisotropic material to be filled, so that a retardation film having various characteristics can be obtained.

Moreover, in the present invention, it is preferable that the material having refractive index anisotropy is a material having liquid crystallinity. With the material having the liquid crystallinity, a liquid crystal structure may be provided when the material is filled in the polymer film, so that the effect can be imparted effectively to the polymer film.

Furthermore, in the present invention, it is preferable that a molecular structure of the material having refractive index anisotropy is in a shape of a rod. By using the refractive index anisotropic material having a structure in the shape of a rod, the refractive index regularity of the above-mentioned polymer film can be reinforced.

Moreover, in the present invention, it is preferable that the material having refractive index anisotropy has a polymerizable functional group. By polymerizing the refractive index anisotropic material using the polymerizable functional group, after filling the polymer film with the refractive index anisotropic material, bleeding out of the refractive index anisotropic material, after the retardation film is formed, can be prevented so that a stable retardation film can be provided.

In the present invention, it is preferable that the concentration gradient of the material having refractive index anisotropy is high concentration on one surface side of the polymer film and low concentration on the other surface side. With such configuration, for example, in the case of forming a polarizing film by directly adhering a polymerizing layer on the retardation film, by adhering the polarizing layer on the low concentration side, specifically, on the surface side, on which the refractive index anisotropic material is not filled, a polarizing film can be obtained without the adhesion being interrupted.

Furthermore, in the present invention, the concentration gradient of the material having refractive index anisotropy may be high concentration on both surface sides of the polymer film and low concentration in the central part. With such configuration, for example, in the case of filling only one surface side with the refractive index anisotropic material, even if the retardation value is insufficient, by making the both surface sides of the polymer film having high concentration, that is, by filling the both surface sides with the refractive index anisotropic material, a sufficient retardation value can be provided.

In the present invention, it is preferable that the retardation value, in the visible light range, of the retardation film on the shorter wavelength side is larger than that of the longer wavelength side. In general, the retardation value of a liquid crystal material used for a liquid crystal layer of a liquid crystal display, in the visible light range, on the shorter wavelength side is larger than that of the longer wavelength side. Therefore, in the case of using the retardation film of the present invention as, for example, an optical compensating plate, there is an advantage that the compensation can be carried out in the all wavelength range in the visible light range.

Moreover, the present invention provides a polarizing film comprising the above-mentioned retardation film directly adhered to a polarizing layer. A polarizing film is usually used with protecting films adhered on the both surfaces of the polarizing layer. However, in the present invention, since one of the protecting films can be substituted by the above-mentioned retardation film, for example, when additional optical compensating plate is required or the like, there is an advantage that other optical compensating plate is not needed to be provided by using the polarizing film of the present invention.

Furthermore, the present invention provides a method for manufacturing a retardation film comprising: a coating process of coating a retardation reinforcing region forming coating solution, in which a material having refractive index anisotropy is dissolved or dispersed in a solvent, on at least one surface side of a polymer film; a penetration process of penetrating the material having the refractive index anisotropy, in the retardation reinforcing region forming coating solution coated in the coating process, into the polymer film surface; and a drying process of drying the solvent in the retardation reinforcing region forming coating solution coated in the coating process. In the present invention, a retardation film can be formed easily by coating the above-mentioned retardation reinforcing region forming coating solution. And also, the retardation value of the obtained retardation film can be changed only by changing the coating amount or the like of the above-mentioned retardation reinforcing region forming coating solution. Therefore, in the present invention, there is an advantage that a retardation film having an optional retardation value can be obtained easily, even in the case of a small amount.

In the above-mentioned invention, the penetration process may be carried out during the drying process. This is because the refractive index anisotropic material may be penetrated in the polymer film during the drying operation by adjusting the drying temperature or the like.

Moreover, in the present invention, it is preferable that, after the drying process, comprising a fixing process of fixing the refractive index anisotropic material penetrated into the polymer film. For example, when the refractive index anisotropic material has a polymerizable functional group or the like, bleeding out of the refractive index anisotropic material from the surface, after the manufacturing, can be prevented by polymerizing the refractive index anisotropic material after the penetration into the polymer film, so that the stability of the retardation film can be improved.

### BRIEF DESCRIPTION OF THE DRAWINGS

FIG. 1 is a schematic cross sectional view showing an example of a retardation film of the present invention.

FIG. 2 is a schematic cross sectional view showing another example of the retardation film of the present invention.

FIGS. 3A, 3B and 3C are process diagrams showing an example of a method for manufacturing a retardation film of the present invention.

FIG. 4 is a SEM photograph showing a cross section of a retardation film of the example 1.

FIG. 5 is a TEM photograph showing a cross section of a retardation film of the example 1.

FIG. 6 is a graph showing the relationship between the coating amount and the retardation in the example 5.

FIG. 7 is a schematic exploded perspective view showing a conventional liquid crystal display.

### DESCRIPTION OF THE PREFERRED EXAMPLES

The present invention includes a retardation film, a polarizing film using the same, and furthermore, a method for manufacturing a retardation film. Hereinafter, each of them will be explained in detail.

A. Retardation Film

First, a retardation film of the present invention will be explained. The retardation film of the present invention is a retardation film, wherein a material having refractive index anisotropy is contained in a polymer film, and the material having refractive index anisotropy has a concentration gradient in a thickness direction of the polymer film.

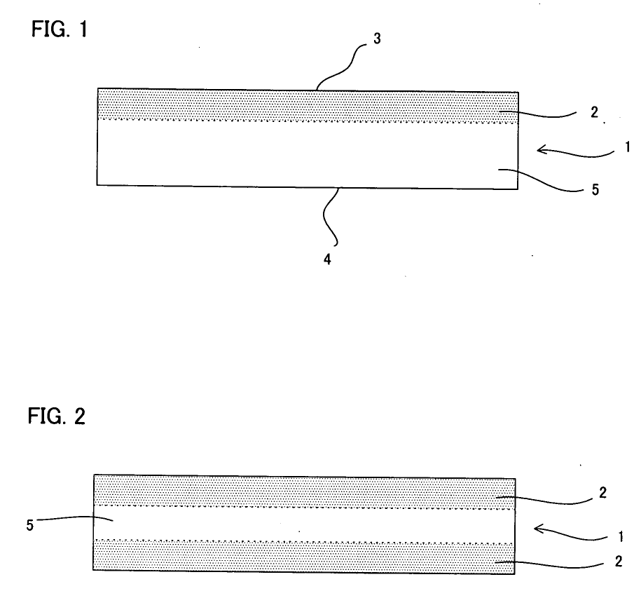

FIG. 1 is a cross sectional view showing an example of the retardation film of the present invention. In the example shown in FIG. 1, a retardation reinforcing region 2 containing the refractive index anisotropic material is formed on one surface side of a polymer film 1. A concentration gradient of the refractive index anisotropic material in this case is high concentration on the surface 3 side, on which the retardation reinforcing region 2 is formed. The refractive index anisotropic material is not contained on the surface 4 side on which the retardation reinforcing region 2 is not formed. The concentration gradient in the present invention includes a case, as mentioned above, in which the material in present in some area, and not present in other area.

In the present invention, since the retardation reinforcing region, in which the refractive index anisotropic material is present, is formed in the retardation film so as to form the concentration gradient of the refractive index anisotropic material, the retardation reinforcing region reinforces the function as the retardation layer. Therefore, various optical functions based on the double refractivity can be provided. For example, as it will be described later, in the case of using a TAC (cellulose triacetate), which acts as a negative C plate, as the polymer film, and using a liquid crystal material having a structure in the shape of a rod as the refractive index anisotropic material, since the above-mentioned retardation reinforcing region reinforces the function as the negative C plate, the function as the negative C plate of the retardation film of the present invention is further reinforced.

In the retardation film of the present invention, as it will be explained in detail in the column of the “C. Method for manufacturing a retardation film”, since the retardation reinforcing region can be formed easily, for example, only by coating the retardation reinforcing region forming coating solution, in which the above-mentioned refractive index anisotropic material is dissolved or dispersed, and penetrating the refractive index anisotropic material from the surface of the polymer film so as to be filled in the polymer film, even when a compensating plate having various kinds of retardation values is needed in a small lot, or the like, a retardation film can be obtained easily at a low cost, and thus it is advantageous.

Moreover, as mentioned above, in the retardation film of the present invention, unlike the conventional ones in which the retardation layer is formed on the base material, since the retardation reinforcing region filled with the refractive index anisotropic material and the base material region without being filled therewith are formed in the retardation film, the conventional problem of the peeling off of the retardation layer can be prevented so as to be used stably.

Hereinafter, each configuration of the retardation film of the present invention will be explained in detail.

1. Polymer Film

A polymer film used in the present invention is not particularly limited. In general, those made of a resin capable of transmitting a light in the visible light range is used preferably. Here, to transmit the light in the visible light range is that an average light transmission ratio in the visible light range of 380 to 780 nm is 50% or more, preferably 70% or more, and particularly preferably 85% or more. For the light transmission ratio, a value measured by an ultraviolet-visible spectrophotometer (for example, UV-3100PC manufactured by Shimadzu Corporation) at a room temperature in the atmosphere is used.

As the polymer film used in the present invention, those having the refractive index regularity are preferable. Although it is not yet clear, it is assumed that the retardation film in the present invention performs the function as an optical functional film such as an optical compensating plate, by obtaining a larger retardation value, for the following reasons. That is, it is assumed that, when the refractive index anisotropic material is filled in the polymer film, the filled refractive index anisotropic material reinforces the refractive index regularity, such as the double refractivity, inherent to the polymer film, and thereby, a retardation film having various characteristics can be obtained. Therefore, as the polymer film used in the present invention, those having some kind of refractive index regularity are used preferably.

The refractive index regularity in the present invention is that, for example, (1) the polymer film acts as the negative C plate, (2) the oriented polymer film has both characteristics of negative C plate and A plate, or the like.

Moreover, in the present invention, as it will be described in detail in the column of the “C. Method for manufacturing a retardation film”, it is preferable that the polymer film has high swelling degree to predetermined solvents. That is because the above-mentioned refractive index anisotropic material is penetrated and filled in the polymer film by coating the retardation reinforcing region forming coating solution, in which the above-mentioned refractive index anisotropic material is dissolved or dispersed in a solvent, onto the surface of the polymer film and swelling by the solvent. Specifically, it is preferable that the polymer film is swelled when the polymer film is soaked in a certain solvent. This phenomenon can be judged visually. For example, the swelling property to a solvent can be checked by forming a polymer film (film thickness: several μm), dropping a solvent thereon, and observing the penetration condition of the solvent.

As materials for constituting such as polymer film, specifically, a cellulose based resin, a polymethyl methacrylate (PMMA), a polycarbonate (PC) and the like can be presented. Among the above, a TAC (cellulose triacetate) can be presented as a particularly preferable resin.

Moreover, in the present invention, for example, an oriented TAC film can also be used preferably.

As to the film thickness of the polymer film used in the present invention, those generally in a range of 10 μm to 200 μm, and in particular in a range of 20 μm to 100 μm can be used preferably.

2. Refractive Index Anisotropic Material

Next, the refractive index anisotropic material used in the present invention will be explained. The refractive index anisotropic material used in the present invention is not particularly limited as long as it is a material capable of filling the polymer film, and also, having a double refractivity.

In the present invention, a material having relatively small molecular weight is used preferably because it is easily filled in the polymer film. Specifically, a material having a molecular weight in a range of 200 to 1200, in particular, in a range of 400 to 800 is used preferably. The molecular weight here refers to the molecular weight before polymerization for the below mentioned refractive index anisotropic material having a polymerizable functional group to be polymerized in the polymer film.

As the refractive index anisotropic material used in the present invention, it is preferable that the molecular structure of the material is in a shape of a rod. That is because the material in a shape of a rod can get into a gap in the polymer film relatively easily.

Moreover, it is preferable that the refractive index anisotropic material used in the present invention is a material having a liquid crystallinity (liquid crystalline molecules). If the refractive index anisotropic material is the liquid crystalline molecules, when the refractive index anisotropic material is filled in the polymer film, it can be in a liquid crystalline state in the polymer film so that the double refractivity of the refractive index anisotropic material can be reflected to the retardation film more effectively.

In the present invention, as the refractive index anisotropic material, a nematic liquid crystalline molecule material, a cholesteric liquid crystalline molecule material, a smectic liquid crystalline molecule material, and a discotic liquid crystalline molecule material can be used. In particular, it is preferable that the refractive index anisotropic material is the nematic liquid crystalline molecule material. In the case of the nematic liquid crystalline molecule material, since several to several hundreds of the nematic liquid crystalline molecules, which have entered into the gap in the polymer film, are aligned in the polymer film, the refractive index anisotropy can be realized more certainly. It is particularly preferable that the above-mentioned nematic liquid crystalline molecule is a molecule having spacers on both mesogen ends. Since the nematic liquid crystalline molecule having spacers on both mesogen ends has flexibility, white turbidity, when getting into the gap in the polymer film, can be prevented.

As the refractive index anisotropic material used in the present invention, those having a polymerizable functional group in the molecule are used preferably. In particular, those having the polymerizable functional group, which can be three-dimensionally cross-linked, are preferable. If those having the polymerizable functional group are used, the refractive index anisotropic material can be polymerized (cross-linked) in the polymer film, after being filled in the polymer film, by the function of the radical generated from a photo-polymerization initiator due to a light irradiation, by the function of the electron beam or the like. Therefore, problems, such as bleeding out of the refractive index anisotropic material after being formed as the retardation film, can be prevented so that a retardation film which can be used stably can be provided.

The “three-dimensionally cross-link” means a state that the liquid crystalline molecules are polymerized three dimensionally with each other so as to be a mesh (network) structure.

The polymerizable functional group is not particularly limited, and a polymerizable functional group, which is polymerized by a function of a radical generated from a photo-polymerization initiator due to the ultraviolet ray irradiation, is used. Specifically, a functional group having at least one ethylenically unsaturated double bond, of which addition polymerization is possible, can be presented. Further specifically, a vinyl group, an acrylate group or the like, with or without a substituent, can be presented.

In the present invention, among the above, a liquid crystalline molecule, whose molecular structure is in a shape of a rod, and having the above-mentioned polymerizable functional group on it send can be used particularly preferably. For example, by using a nematic liquid crystalline molecule having polymerizable functional groups on both ends, they can be polymerized with each other three-dimensionally so as to provide a mesh (network) structure state. Therefore, a stronger polymer film can be obtained.

Specifically, a liquid crystalline molecule having an acrylate group on its end can be used preferably. The specific examples of the nematic liquid crystalline molecule having an acrylate group on its end will be shown by the below-mentioned chemical formulae (1) to (6).

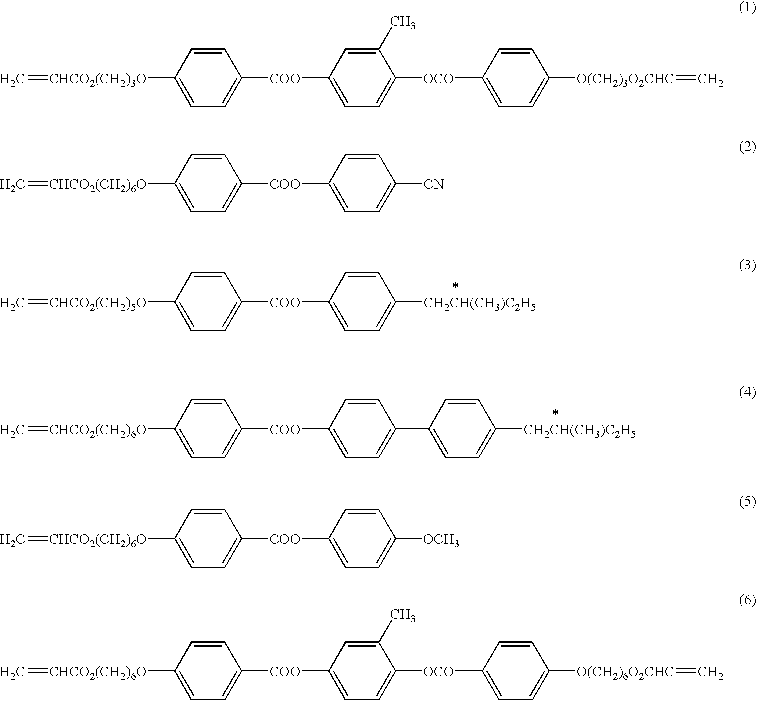

Here, the liquid crystalline molecules shown by the chemical formulae (1), (2), (5) and (6) can be prepared according to the methods disclosed in Makromol Chem. 190, 3201-3215 (1989) by D. J. Broer, et al. or Makromol Chem. 190, 2250 (1989) by D. J. Broer, et al., or a method similar thereto. Moreover, the preparation of the liquid crystalline molecules shown by the chemical formulae (3) and (4) is disclosed in DE 195,04,224.

Moreover, as the specific examples of the nematic liquid crystalline molecules having an acrylate group on its end, those shown by the below-mentioned chemical formulae (7) to (17) can also be presented. 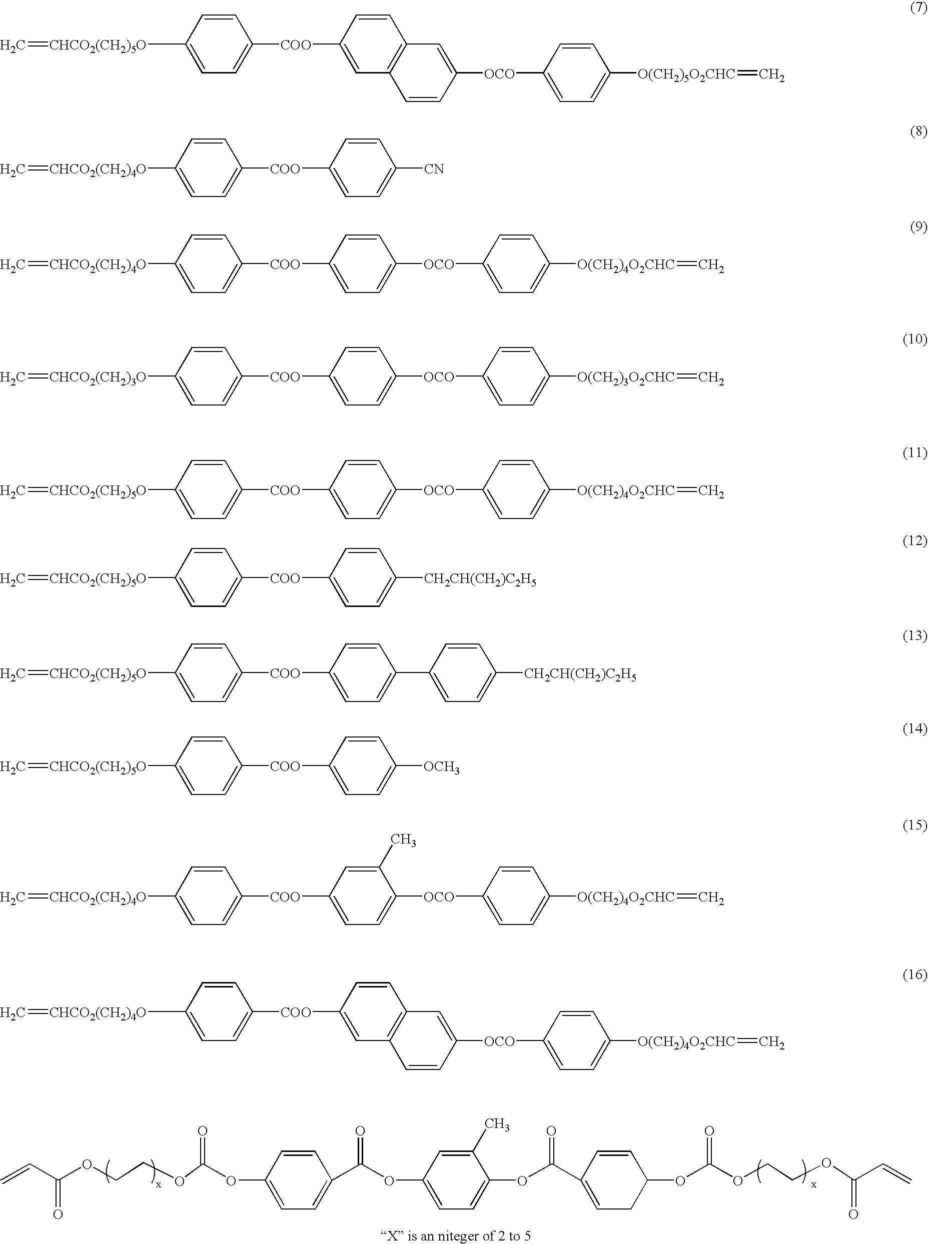
3. Concentration Gradient

In the present invention, the above-mentioned refractive index anisotropic material is characterized in that it has a concentration gradient in the thickness direction of the above-mentioned polymer film.

In the present invention, the concentration gradient is not particularly limited as long as the concentrations at optional two points in the thickness direction differ with each other. However, in the present invention, there are two preferable embodiments: an embodiment that the concentration gradient of the refractive index anisotropic material is higher concentration on one surface side of the polymer film, and is lower concentration on the other surface side (first embodiment); and an embodiment that the concentration gradient of the refractive index anisotropic material is higher concentration on the both surface sides of the polymer film, and is lower concentration in the central part (second embodiment). Hereinafter, each embodiment will be explained.

### (1) First Embodiment

The first embodiment of the present invention is an embodiment that the concentration gradient of the refractive index anisotropic material is higher concentration on one surface side of the polymer film, and is lower concentration on the other surface side. The first embodiment is shown schematically in FIG. 1. As shown in FIG. 1, in this embodiment, a retardation reinforcing region 2 containing the refractive index anisotropic material is formed on one surface side 3 of a polymer film 1. And a base material region 5 is formed on the other surface side 4.

In this embodiment, it is characterized in that the retardation reinforcing region containing the refractive index anisotropic material is formed on one surface side of the polymer film. The concentration gradient of the refractive index anisotropic material in the retardation reinforcing region is generally made higher concentration on the surface side of the polymer film, and is made lower concentration on the center side in the thickness direction of the polymer film. And the base material region, not containing the refractive index anisotropic material, is formed on the other surface side of the polymer film.

In this embodiment, since the retardation reinforcing region is formed on one surface side of the polymer film as mentioned above, the following advantages can be obtained.

That is, since the refractive index anisotropic material is not contained on the above-mentioned base material region side, the nature of the polymer film remains as it is. Therefore, there are advantages such as, for example, when the adhesive property of the polymer film itself is good or the like, a polarizing film can easily be obtained by adhering a polarizing layer on the above-mentioned base material region side. Moreover, the strength of the retardation reinforcing region containing the refractive index anisotropic material may be deteriorated in some cases. However, since the above-mentioned base material region is provided, the strength as the retardation film can be maintained, and thus, it is advantageous.

The thickness of the retardation reinforcing region in the present invention is generally in a range of 0.5 μm to 8 μm, and it is particularly preferably in a range of 1 μm to 4 μm. When it is smaller than the above-mentioned range, a sufficient retardation value cannot be obtained. Furthermore, it is difficult to have a thickness thicker than the above-mentioned range.

Whether or not, the concentration gradient of the refractive index anisotropic material is as this embodiment, can be determined by the composition analysis of the retardation reinforcing region and the base material region.

As the composition analyzing method, a method of measuring the concentration distribution of the material in the thickness direction by cutting a retardation film by the GSP (gradient shaving preparation) so as to provide the cross section in the thickness direction, and carrying out the time of flight type secondary ion mass spectrometer (TOF-SIMS), or the like can be presented.

### (1) Second Embodiment

The second embodiment of the present invention is an embodiment that the concentration gradient of the refractive index anisotropic material is higher concentration on the both surface sides of the polymer film, and is lower concentration in the central part. The second embodiment is shown schematically in FIG. 2. As shown in FIG. 2, in this embodiment, a retardation reinforcing region 2 containing a refractive index anisotropic material is formed on both surface sides of a polymer film 1. And a base material region 5 is formed in the central part.

In this embodiment, the retardation reinforcing region containing the refractive index anisotropic material is formed on the both surface sides of the polymer film. The concentration gradient of the refractive index anisotropic material in the retardation reinforcing region is generally made higher on the surface side of the polymer film, and is made lower on the center side in the thickness direction of the polymer film. And the base material region not containing the refractive index anisotropic material is formed at the central part, in the thickness direction, of the polymer film.

Since the film thickness of the retardation reinforcing region in this case is same as that of the above-mentioned first embodiment, explanation is omitted here.

In this embodiment, since the retardation reinforcing region is formed on the both surface sides of the polymer film as mentioned above, the following advantages can be obtained.

That is, in this embodiment, since the retardation reinforcing region is provided on the both surface sides, the retardation value in the retardation reinforcing region is expected to be a double of that in the above-mentioned first embodiment. Therefore, it is advantageous in cases in which greater retardation value is required, such that the retardation value of the above-mentioned first embodiment is not sufficient, or the like.

Whether or not, the concentration gradient of the refractive index anisotropic material is as this embodiment, can be determined by the composition analysis of the retardation reinforcing region and the base material region by the same method as in the case of the above-mentioned first embodiment.

4. Retardation Film

It is preferable that the retardation film of the present invention has the retardation value in the visible light range is larger on the shorter wavelength side, than that of the longer wavelength side. In general, the retardation value, in the visible light range, of the liquid crystal material used for a liquid crystal layer of a liquid crystal display is larger on the shorter wavelength side, than that of the longer wavelength side. Therefore, when the retardation film of the present invention is used, for example, as an optical compensating plate, there is an advantage that the compensation can be carried out for the all wavelength in the visible light range.

In order to make the retardation value in the visible light range of the retardation film larger on the shorter wavelength side than that of the longer wavelength side, it is preferable to select, for the polymer film and the refractive index anisotropic material, those having larger retardation value, in the visible light range, on the shorter wavelength side than that of the longer wavelength side. However, since the TAC film, used for the protecting film of the polarizing layer (such as a polyvinyl alcohol (PVA)) does not have the retardation value as mentioned above, it is preferable to select a refractive index anisotropic material having the above-mentioned retardation value.

Moreover, the retardation film of the present invention may further have other layers laminated directly. For example, when the retardation value is insufficient as the retardation film, another retardation layer may further be laminated directly. Moreover, as it will be described later, other optical functional layers, for example, a polarizing layer may be laminated directly.

5. Application

The retardation film of the present invention can be used for various applications as the optical functional film. Specifically, an optical compensating plate, a retardation plate, a visual angle compensating plate, an elliptical polarization plate, a brightness improving plate and the like can be presented.

In the present invention, the application as the optical compensating plate is particularly preferable. Specifically, it can be used for the application as a negative C plate by using a TAC film as the polymer film and using a liquid crystalline compound, whose molecular structure is in a shape of a rod, as the refractive index anisotropic material.

Moreover, the retardation film of the present invention can be used as various optical functional films used for a liquid crystal display. For example, when the retardation film of the present invention is used as an optical compensating plate as the negative C plate as mentioned above, it can be used preferably for a liquid crystal display having a VA mode or OCB mode liquid crystal layer.

B. Polarizing Film

Next, the polarizing film of the present invention will be explained. The polarizing film of the present invention is formed by directly adhering a polarizing layer onto the retardation film explained in the above-mentioned column of the “A. Retardation film” with a polyvinyl alcohol (PVA) based adhesive or the like.

In general, the polarizing layer has protecting layers on both surfaces thereof. However, in the present invention, by providing the above-mentioned retardation film for the polarizing layer on one side thereof, for example, a polarizing film having an optical compensation function can be obtained.

In the present invention, the first embodiment of the above-mentioned retardation film, that is, the retardation film of the embodiment, that the concentration gradient of the refractive index anisotropic material is higher concentration on one surface side of the polymer film, and is lower concentration on the other surface side, can be used preferably. The polarizing layer, in general, is made of a polyvinyl alcohol (PVA). In this case, although it depends on the kind of the polymer film, the surface on the side without the refractive index anisotropic material has a better adhesive property.

C. Method for Manufacturing Retardation Film

A method for manufacturing a retardation film in the present invention comprises: a coating process of coating a retardation reinforcing region forming coating solution, in which a material having refractive index anisotropy is dissolved or dispersed in a solvent, on at least one surface side of a polymer film; a penetration process of penetrating the material having the refractive index anisotropy, in the retardation reinforcing region forming coating solution coated in the coating process, into the polymer film surface; and a drying process of drying the solvent in the retardation reinforcing region forming coating solution coated in the coating process.

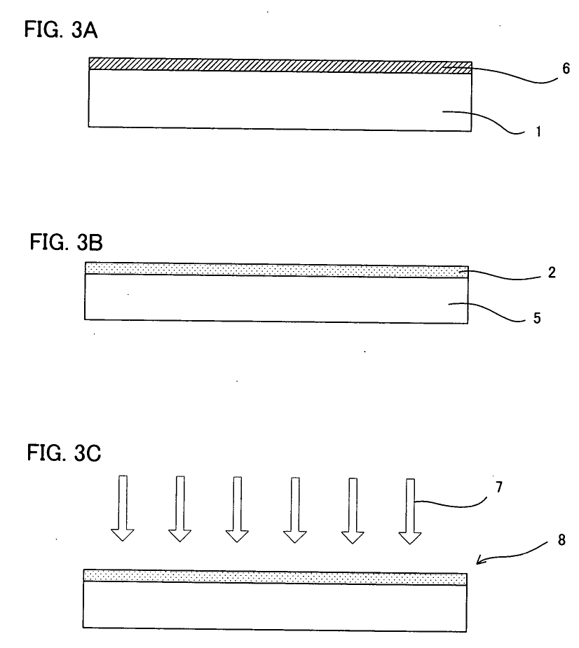

The method for manufacturing a retardation film of the present invention will be explained specifically with referring to the drawings. FIGS. 3A, 3B and 3C are process diagrams showing an example of the method for manufacturing a retardation film of the present invention. First, as shown in FIG. 3A, a coating process, of coating a retardation reinforcing region forming coating solution 6 onto a polymer film 1, is carried out. Then, as shown in FIG. 3B, a penetration process, of penetrating the above-mentioned refractive index anisotropic material in the retardation reinforcing region forming coating solution into the above-mentioned polymer film surface, is carried out. And then, a drying process, of drying the above-mentioned solvent in the above-mentioned retardation reinforcing region forming coating solution coated in the above-mentioned coating process, is carried out. Thereby, the refractive index anisotropic material in the above-mentioned retardation reinforcing region forming coating solution is penetrated from the polymer film surface so that a retardation reinforcing region 2, containing the refractive index anisotropic material on the polymer film surface side, is formed. Accordingly, the retardation reinforcing region 2, which contains the refractive index anisotropic material, and the base material region 5, which contains no refractive index anisotropic material, are formed in the polymer film. Then, finally, as shown in FIG. 3C, a retardation film 8 is formed by carrying out a fixing process of polymerizing the refractive index anisotropic material contained in the polymer film by the function of the photo polymerization initiator by irradiating an ultraviolet ray 7 from the above-mentioned retardation reinforcing region 2 side.

By the method for manufacturing a retardation film of the present invention, the retardation film can be formed easily by coating the above-mentioned retardation reinforcing region forming coating solution. And also, the retardation value of the obtained retardation film can be changed by only changing the coating amount or the like of the above-mentioned retardation reinforcing region forming coating solution. Therefore, in the present invention, a retardation film having an optional retardation value can be obtained easily even in the case of a small amount, and thus, it is advantageous.

Hereinafter, the method for manufacturing a retardation film of the present invention will be explained by each step.

1. Coating Process

The coating process in the present invention is a process of coating a retardation reinforcing region forming coating solution, in which a refractive index anisotropic material is dissolved or dispersed in a solvent, on at least one surface side of a polymer film.

In the present invention, the retardation value of the obtained retardation film can be changed by the coating amount of the retardation reinforcing region forming coating solution in the coating process.

The retardation reinforcing region forming coating solution used in the present invention contains at least a solvent and a refractive index anisotropic material dissolved or dispersed in the above-mentioned solvent. According to a needed, other additives may be added. As such additives, specifically, when the used refractive index anisotropic material is a photo-curing type, a photo-polymerization initiator or the like can be presented. Additionally, a polymerization inhibitor, a leveling agent, a chiral agent, a silane coupling agent or the like can be presented.

Since the refractive index anisotropic material used for the above-mentioned retardation reinforcing region forming coating solution is same as those described in the above-mentioned column of “A. Retardation film”, explanation is omitted here. When the refractive index anisotropic material has a polymerizable functional group and the below-mentioned fixing process (process of polymerizing the refractive index anisotropic material) is carried out in the manufacturing process for the retardation film, since the refractive index anisotropic material contained in the retardation film is polymerized by a predetermined polymerization degree, strictly speaking, it is different from that used for the retardation reinforcing region forming coating solution.

Moreover, the solvent used for the above-mentioned retardation reinforcing region forming coating solution is not particularly limited as long as it is a solvent capable of sufficiently swelling the polymer film and capable of dissolving or dispersing the above-mentioned refractive index anisotropic material. Specifically, when the polymer film is TAC and the refractive index anisotropic material is the nematic liquid crystal having the acrylate on its end, a cyclohexanone can be used preferably.

Although the concentration of the refractive index anisotropic material in the solvent, in the retardation reinforcing region forming coating solution of the present invention, is not particularly limited, it is generally in a range of 5% by mass to 40% by mass, and particularly preferably in a range of 15% by mass to 30% by mass.

Moreover, although the coating amount onto the polymer film differs depending on the retardation value required for the obtained retardation film, the refractive index anisotropic material is in a range of 0.8 g/m² to 6 g/m², and particularly preferably in a range of 1.6 g/m² to 5 g/m².

The coating method in this process is not particularly limited as long as it is a method capable of coating the retardation reinforcing region forming coating solution evenly onto the polymer film surface, and a method such as bar coating, blade coating, spin coating, die coating, slit reverse, roll coating, dip coating, ink jet method, micro gravure method and the like can be used. In the present invention, it is particularly preferable to use blade coating, die coating, slit reverse and roll coating.

2. Penetration Process and Drying Process

In the present invention, after the above-mentioned coating process: a penetration process of penetrating the above-mentioned refractive index anisotropic material, contained in the above-mentioned retardation reinforcing region forming coating solution coated in the above-mentioned coating process, into the above-mentioned polymer film surface; and a drying process of drying the above-mentioned solvent, contained in the above-mentioned retardation reinforcing region forming coating solution coated in the above-mentioned coating process, are carried out.

The above-mentioned penetration process, which is a process of leaving the polymer film after coating so that the refractive index anisotropic material is sufficiently penetrated and taken into the polymer film, may be carried out simultaneously with the drying process depending on the kind of the solvent to be used or the like.

In the above-mentioned drying process, which is a process of drying the solvent in the retardation reinforcing region forming coating solution, the temperature and the time may differ drastically depending on the kind of the solvent to be used and whether or not it is carried out simultaneously with the penetration process. For example, when a cyclohexanone is used as the solvent and it is carried out simultaneously with the penetration process, the drying process is carried out at a temperature generally in a range of the room temperature to 120° C., preferably in a range of 70° C. to 100° C., and for the time of about 30 seconds to 10 minutes, preferably about 1 minute to 5 minutes.

3. Fixing Process

Furthermore, when the refractive index anisotropic material used has a polymerizable functional group, a fixing process is carried out for polymerizing the refractive index anisotropic material so as to be a polymer. By carrying out the fixing process as mentioned above, bleeding out of the refractive index anisotropic material, once taken into the polymer film, can be prevented so that the stability of the obtained retardation film can be improved.

For the fixing process in the present invention, various methods are used depending on the refractive index anisotropic material to be used. For example, when the refractive index anisotropic material is a cross-linking compound, a photo-polymerization initiator is contained and an ultraviolet ray or an electron beam is irradiated, and when it is a thermosetting compound, it is heated.

The present invention is not limited to the above-mentioned embodiment. The above-mentioned embodiments are merely examples, and any one having the substantially same configuration and the same effects, as the technological idea disclosed in the scope of the claims of the present invention, is included in the technological scope of the present invention.

### EXAMPLES

Hereinafter, the present invention will be explained specifically with reference to the examples.

### Example 1

As the refractive index anisotropic material, a photo polymerizable liquid crystal compound (the below-mentioned compound (1)) was dissolved in a cyclohexanone by 20% by mass. It was coated onto a TAC film (manufactured by Fuji Photo Film Co., Ltd., product name: TF80UL) by bar coating. Then, it was heated at 90° C. for 4 minutes so as to remove the solvent. Furthermore, by irradiating an ultraviolet ray to the coated surface, the above-mentioned photo polymerizable liquid crystal compound was fixed to produce a retardation film. The obtained retardation film was used as a sample and evaluated for the below-mentioned items. 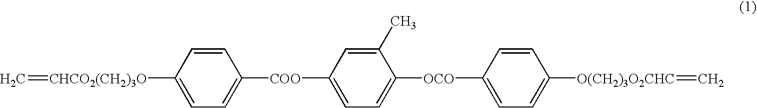
1. Optical Characteristics

The retardation of the sample was measured by an automatic double refractivity measuring device (manufactured by Oji Scientific Instruments, product name: KOBRA-21ADH). By introducing the measuring light perpendicularly or obliquely to the sample surface, the anisotropy of increasing the retardation of the base material film was confirmed from a chart of the optical retardation and the incident angle of the measuring light. Moreover, by the same measuring device, the three-dimensional refractive index was measured. As a result, with the premise that the refractive indices in the plane direction are Nx, Ny, and the refractive index in the thickness direction is Nz, Nz<Nx=Ny is satisfied as shown in the below-mentioned table 1 so as to provide a negative C plate. Therefore, combining this result with the above mentioned measuring results of the retardation, the liquid crystal molecules are considered to be aligned homogeneously which is randomly aligned in the plane.

TABLE 1

| Film thickness | 1.1 μm |
|---|---|
| Nx | 1.633 |
| Ny | 1.633 |
| Nz | 1.533 |

2. Cross Section Observation by SEM

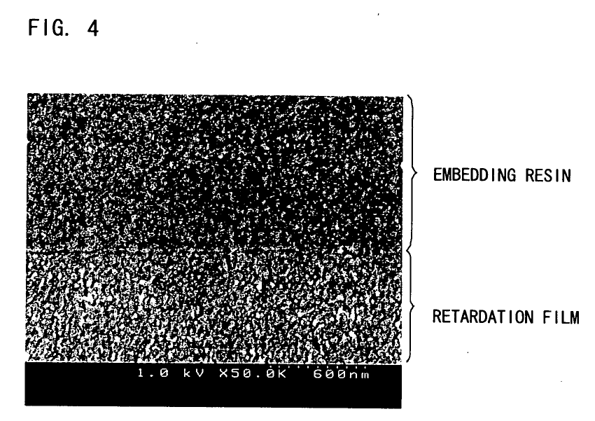

An embedding resin was coated on the liquid crystal coated surface of the sample. It was cut in the thickness direction, and the cross section of the sample was observed by the SEM. The results are shown in FIG. 4. As it is apparent from FIG. 4, there was no layer present between the film surface and the embedding resin. Therefore, combining this result with the above mentioned measuring results of the retardation, it was judged that the liquid crystal compound was penetrated in the polymer film.

3. Cross Section Observation by TEM

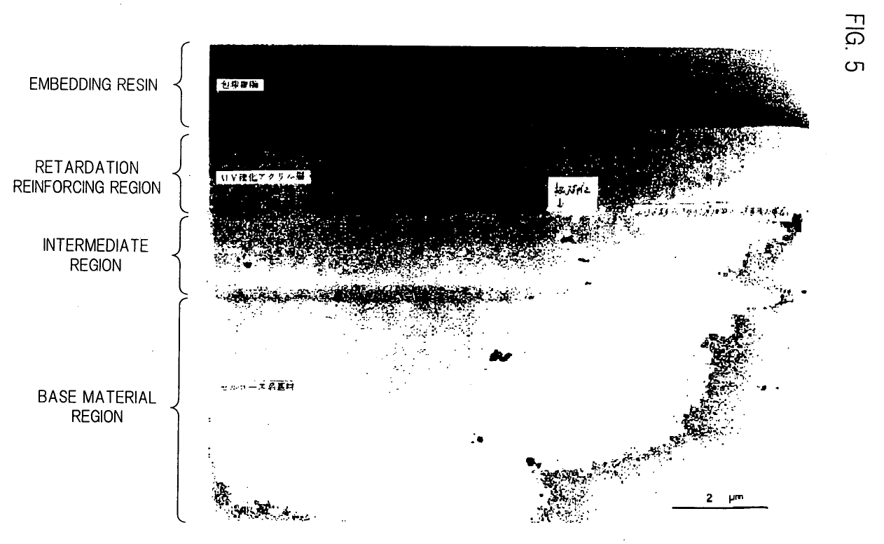

A surface protection of the liquid crystal coated surface of the sample was carried out by coating with a metal oxide. After embedding the sample with an epoxy resin, it was adhered onto a cryo supporting platform. Then, it was trimmed and figured by a cryo system with a diamond knife installed ultra microtome. It was subjected to a vapor dying by the metal oxide, an ultra thin piece was produced, and then, the TEM observation was carried out. The results are shown in FIG. 5. As it is apparent from FIG. 5, it was found out that the refractive index anisotropic material penetrated side of the sample was separated into three layers (a retardation reinforcing region, an intermediate region, and a base material region).

4. Haze

To examine the transparency of the sample, the haze value was measured by a turbidimeter (manufactured by Nippon Denshoku Industries Co., Ltd., product name: NDH2000). The result was 0.35%, which is preferable.

5. Adhesion Test

To examine the adhesion, a peeling test was carried out. The peeling test was carried out as follows. Cuts of 1 mm width grid were made on the obtained sample. An adhesive tape (manufactured by NICHIBAN CO., LTD., Cellotape (registered trademark)) was adhered on the liquid crystal surface, the tape was peeled off and it was observed visually. As a result, the adhesion degree was 100%.
Adhesion degree (%)=(part which was not peeled off/tape-adhered region)×100
6. Humidity and Heat Resistance Test

After soaking the sample in hot water of 90° C. for 60 minutes, the optical characteristics and the adhesion were measured by the above-mentioned methods. As a result, comparing before and after the test, no change of the optical characteristics and the adhesion was observed.

7. Water Resistance Test

After soaking the sample in pure water for one day under the room temperature (23.5° C.), optical characteristics and the adhesion were measured by the above-mentioned methods. As a result, comparing before and after the test, no change of the optical characteristics and the adhesion was observed.

### Example 2

A retardation film was produced in the same manner as in the example 1, except that the solvent of the example 1 was changed to a solvent mixture of a cyclohexanone and a MEK (solvent ratio 7:1). The obtained retardation film was subjected to the optical characteristics, the adhesion, the humidity and heat resistance test, and the water resistance test in the same manner as in the example 1. As a result, the same results as in the example 1 were obtained.

### Example 3

A retardation film was produced in the same manner as in the example 1, except that the solvent of the example 1 was changed to a solvent mixture of a cyclohexanone and a MEK (solvent ratio 7:1), and that the coating was carried out by die coating (wet coating amount 10.5 g/m², drying: 90° C.×4 minutes). The obtained retardation film was evaluated in the same manner as in the example 1. As a result, the same results as in the example 1 were obtained.

### Example 4

The contact angles of the retardation reinforcing region surface and the base material region surface of the retardation film obtained in the example 1 were measured. Specifically, the contact angles of the retardation reinforcing region surface and the base material region surface (TAC surface) to pure water were measured by a contact angle measuring device (manufactured by Kyowa Interface Science Co., LTD., CA-Z type). The contact angle was measured 30 seconds after dropping 0.1 ml of pure water onto the measuring surface. As a result, the contact angle of the retardation reinforcing region surface was 62.6° and the contact angle of the base material region surface was 57.3°. The retardation reinforcing region surface has a lower value, leading to a result that the retardation reinforcing region surface has higher hydrophilic property.

### Example 5

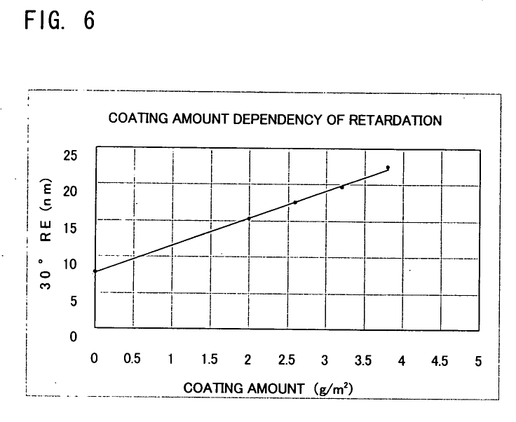

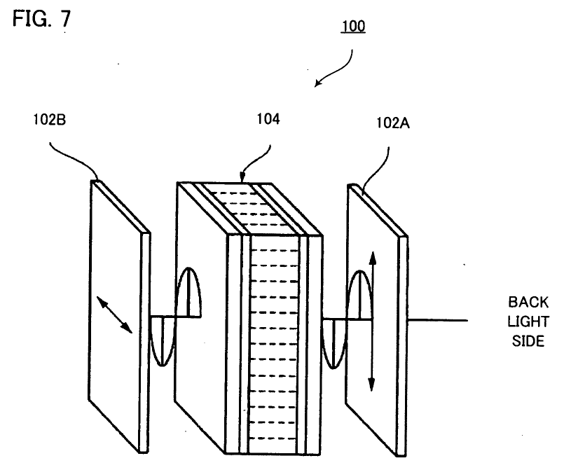

Samples were produced in the same manner as the example 4 except that the dry coating amount was changed to 2.1, 2.6, 3.2, 3.8 g/m², and the same evaluation was carried out. As a result, the same results were obtained. Furthermore, as shown in FIG. 6, a linear relationship was found between the coating amount and the retardation, so that it was revealed that the retardation can be controlled by the coating amount.

What is claimed is:

1. A retardation film, wherein a material having refractive index anisotropy is contained in a polymer film, and
the material having refractive index anisotropy has a concentration gradient in a thickness direction of the polymer film.

2. The retardation film according to claim 1, wherein the polymer film has regularity in the refractive index.

3. The retardation film according to claim 1, wherein the material having refractive index anisotropy is a material having liquid crystallinity.

4. The retardation film according to claim 1, wherein a molecular structure of the material having refractive index anisotropy is in a shape of a rod.

5. The retardation film according to claim 1, wherein the material having refractive index anisotropy has a polymerizable functional group.

6. The retardation film according to claim 1, wherein the concentration gradient of the material having refractive index anisotropy is high concentration on one surface side of the polymer film and low concentration on the other surface side.

7. The retardation film according to claim 1, wherein the concentration gradient of the material having refractive index anisotropy is high concentration on both surface sides of the polymer film and low concentration in a central part.

8. The retardation film according to claim 1, wherein the retardation value, in the visible light range, of the retardation film on the shorter wavelength side is larger than that of the longer wavelength side.

9. A polarizing film comprising the retardation film according to claim 1 directly adhered to a polarizing layer.

10. A method for manufacturing a retardation film comprising:
a coating process of coating a retardation reinforcing region forming coating solution, in which a material having refractive index anisotropy is dissolved or dispersed in a solvent, on at least one surface side of a polymer film;
a penetration process of penetrating the material having the refractive index anisotropy, in the retardation reinforcing region forming coating solution coated in the coating process, into the polymer film surface; and
a drying process of drying the solvent in the retardation reinforcing region forming coating solution coated in the coating process.

11. The method for manufacturing a retardation film according to claim 10, wherein the penetration process is carried out during the drying process.

12. The method for manufacturing a retardation film according to claim 10, after the drying process, comprising a fixing process of fixing the refractive index anisotropic material penetrated into the polymer film.
